(19) United States
(12) Patent Application Publication
(10) Pub. No.: US 2016/0335617 A1
(43) Pub. Date: Nov. 17, 2016

(54) Authentication Payment and Loyalty Program Integration with Self Service Point of Sale Systems

(71) Applicant: AT&T INTELLECTUAL PROPERTY I, L.P., Atlanta, GA (US)

(72) Inventors: Brian M. Novack, St. Louis, MO (US); Mehmet Ozkan, Allen, TX (US); Rodney Brandenburgh, Acworth, GA (US); Pramod Pateel, Suwanee, GA (US); Tim Johnson, Eatonton, GA (US); William Shaw, Kennesaw, GA (US)

(73) Assignee: AT&T INTELLECTUAL PROPERTY I, L.P., Atlanta, GA (US)

(21) Appl. No.: 14/709,670

(22) Filed: May 12, 2015

(51) Int. Cl. G06Q 20/20; G06Q 20/40

(52) U.S. Cl. CPC G06Q 20/202; G06Q 20/40145

(57) ABSTRACT

A method for facilitating purchases from a point of sale device using a biometric identifier includes receiving a biometric identifier and a point of sale (POS) identifier from a point of sale device. A user is identified based on the biometric identifier. It is then determined whether the user is authorized to request a purchase at the point of sale identified by the point of sale identifier. A purchase request authorization and user preferences of the user are transmitted to the point of sale device in response to determining that the user is authorized to request a purchase at the point of sale device.

### BACKGROUND

The present disclosure relates generally to point of sale systems, and more particularly to payments at point of sale systems using biometric authentication.

Point of sale systems, such as vending machines, typically accept coins, paper currency, and financial instruments such as credit cards. Coins are being used less often and are not convenient for high value purchases. Paper currency is typically only accepted when bills are in good condition. A currency accepting device must be periodically updated to identify both old currency and new currency. Paper currency must be reasonably free from folds and creases in order to be identified and accepted. Card readers allow a user to swipe a financial instrument such, as a credit card, however, card readers cannot identify who is using the financial instrument. As such, credit cards can be used fraudulently.

### SUMMARY

In one embodiment, a method for facilitating purchases from a point of sale device using a biometric identifier includes receiving a biometric identifier and a point of sale (POS) identifier from a point of sale device. A user is identified based on the biometric identifier. It is then determined whether the user is authorized to request a purchase at the point of sale device identified by the point of sale identifier. A purchase request authorization and user preferences of the user are transmitted to the point of sale device in response to determining that the user is authorized to request a purchase at the point of sale device.

The user preferences can be based on prior purchases made by the user and reflect one of parental restrictions and legal restrictions. User preferences can also be based on information provided by a user (e.g., items that a user likes). User Information pertaining to products a user is authorized to purchase can be transmitted from an authorization and payment server (AP server) to the POS device for display to the user.

In one embodiment, an indication is received by the AP server from the POS device indicating that the user is attempting to make a purchase for an amount (e.g., dollar amount) above a threshold. In response, the AP server transmits a request to the POS device to request additional authentication from a user. Additional authentication from the user is transmitted by the POS device to the AP server which then determines if the additional authentication is valid. In response to determining that the additional authentication is valid, the AP server transmits authorization for the purchase amount above the threshold.

A user can request enrollment into the system and provides one or more biometric identifiers, personal information, and one or more financial instruments that can be used for purchases. Purchases made by a user are recorded by the AP server in response to receipt of a purchase record from the POS device after a user has made a purchase.

A system and computer readable medium for authorizing purchases via a point of sale device using a biometric identifier are also described herein.

### BRIEF DESCRIPTION OF THE DRAWINGS

FIG. 1 depicts a system for authorizing purchases via a point of sale device using a biometric identifier;

FIGS. 2A and 2B depict a flowchart of a method for enrolling a user in the system shown in FIG. 1 according to an embodiment;

FIGS. 3A and 3B depict a flowchart of a method for facilitating a purchase via a point of sale device using a biometric identifier according to an embodiment; and

FIG. 4 depicts a high level block diagram of a computer for implementing one or more components of the system of FIG. 1.

### DETAILED DESCRIPTION

In one embodiment, purchases can be made by a user using one or more biometric identifiers as a primary authentication and one or more additional authentication factors. The biometric identifiers and the additional authentication factors are associated with a user and the user's financial instrument, such as a credit card. A user can make a purchase via a point of sale device using a biometric identifier, such as a finger print. The biometric identifier and transaction information are sent from the point of sale device to an authentication and payment server. The authentication and payment server communicates with a biometric server to determine and verify the user's identity. The authentication and payment server also communicates with a payment server to determine whether to authorize a purchase requested by the user based on responses to communications with a financial institution server. If a purchase is authorized and completed, the authentication and payment server transmits transaction information to the financial institution server and the user. No financial information is provided by the user to the point of sale device. In addition, a user does not have to carry a wallet, their financial instruments (such as credit/debit cards) or a device (such as a smart phone) containing data related to their financial instruments.

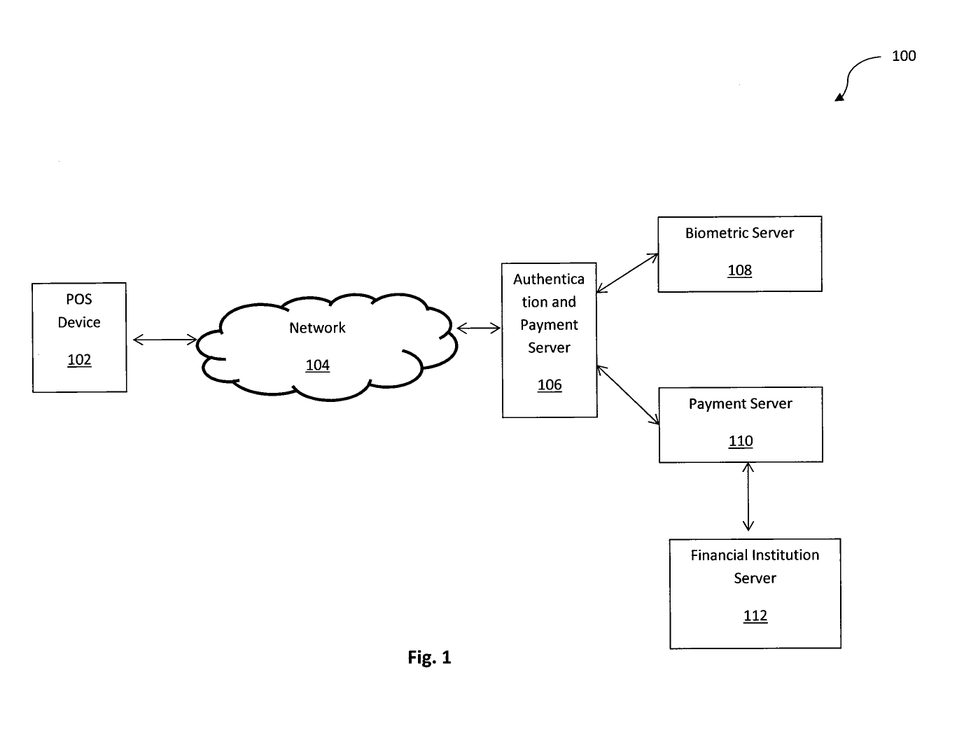

FIG. 1 depicts a system 100 for purchases via a point of sale device using biometric authentication. Point of Sale (POS) device 102, in one embodiment, is a vending machine (e.g., a soda or candy machine), but can be any point of sale device, such as a hand held or table top device used by a merchant. POS device 102 is in communication with authentication and payment server (“AP server”) 106 via network 104 which can be wired or wireless or a combination of wired and wireless. AP server 106 is in communication with biometric server 108 and payment server 110. AP server 106, biometric server 108, and payment server 110, in one embodiment, are servers but can be any type of computer such as a desktop, laptop, etc. Payment server 110 is in communication with financial institution server 112 (“financial server”) which, in one embodiment, is a server, but can be any type of computer capable of communicating with payment server 110. Financial server 112, in one embodiment, is a server associated with a particular financial institution. For example, financial server 112 can be a server of a financial institution associated with a financial instrument of a user (i.e., a financial institution that issued the financial instrument, such as a credit card, to the user).

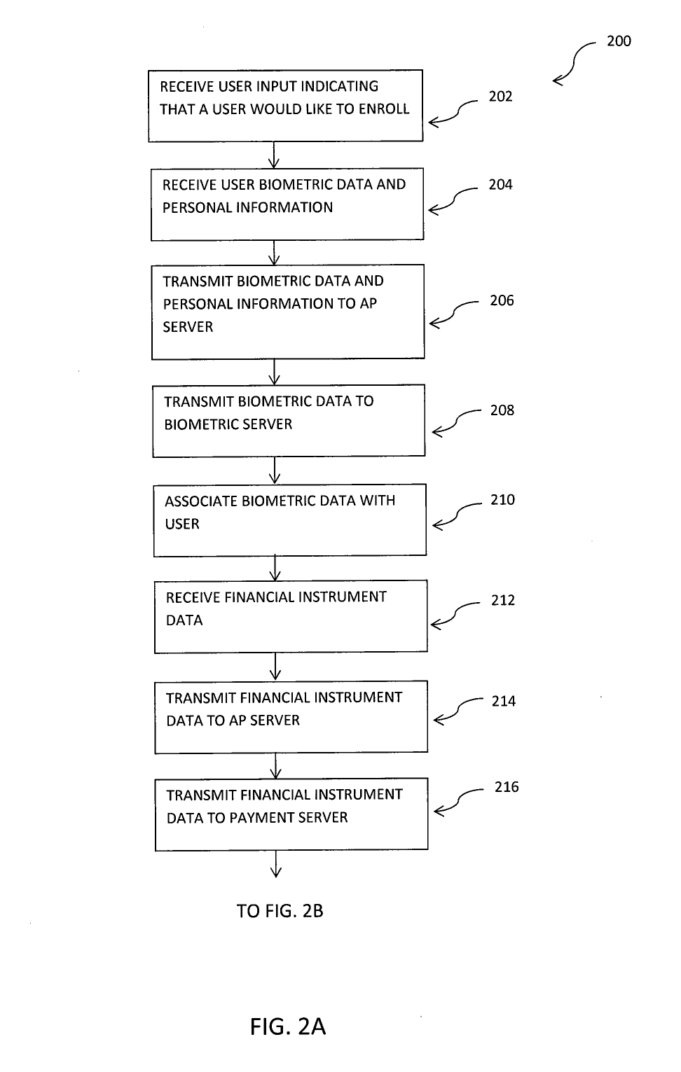

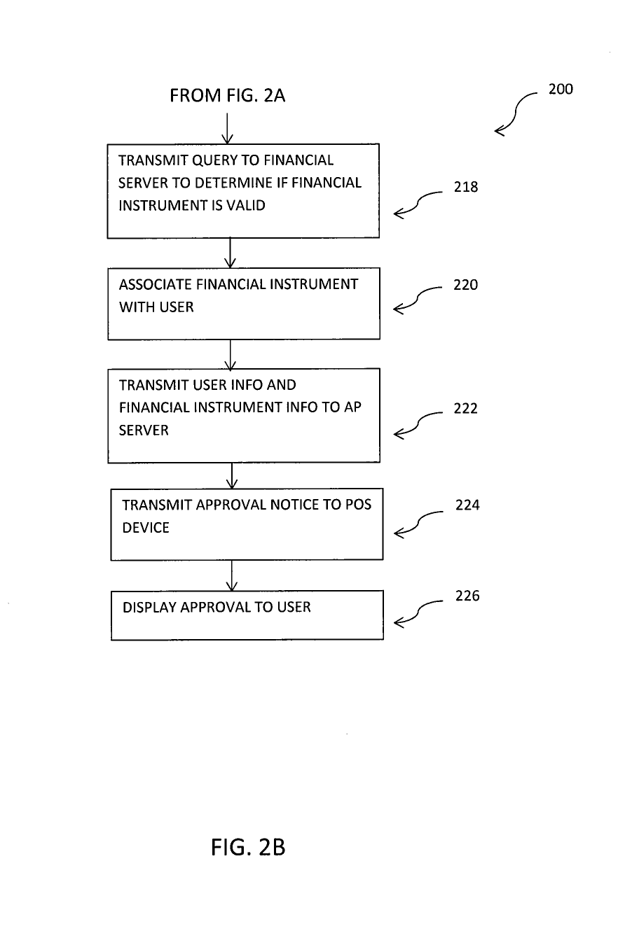

A user must enroll with system 100 prior to making purchases using a biometric identifier. In one embodiment, a user can use a point of sale device for enrolling. FIGS. 2A and 2B depict a method 200 for enrolling a user according to one embodiment. At step 202, user input indicating that a user would like to enroll is received. In one embodiment, the user input is received at POS device 102 but could be received via other devices, such as a computer (e.g., the user's personal computer), a user's mobile device (e.g., a user's smart phone), etc. In response to an enrollment request, POS device 102 requests the user to provide a biometric identifier and personal information.

At step 204, a user's biometric data and personal information are received by POS device 102. In one embodiment, the user's biometric data comprises fingerprint data acquired via a fingerprint reader of POS device 102. Other devices can be used to obtain other types of biometric data in addition to, or instead of, fingerprint data. For example, facial features, retinal features, iris features, voice, palm print, DNA, gait and other biometric features may be used in lieu of, or in addition to fingerprints to identify a user. The user's personal information, in one embodiment, comprises a user's name but can also include additional information such as a user's address, date of birth, demographic information, etc.

At step 206, the user's biometric data and personal information are transmitted from POS device 102 to AP server 106 via network 104. In one embodiment, the biometric data and personal information are encrypted before transmission for security. At step 208, the user's biometric data and personal information are transmitted from AP server 106 to biometric server 108.

At step 210, the user's biometric data is associated with the user by biometric server 108. In one embodiment, biometric data and personal information for a particular user are stored in a record of a database. The database can be queried using the biometric data to identify a user associated with the biometric data.

At step 212, POS device 102 receives financial instrument data from the user in response to a request from POS device 102. In one embodiment, a user swipes a financial instrument, such as a credit and/or debit card. In other embodiments, a user can enter financial instrument data via other methods. For example, a user can enter a credit card, checking, and/or savings account number or other information via an interface of the point of sale device (e.g., keypad and/or touch screen) that can be used to charge a user for a purchase.

At step 214, the user's financial instrument data is transmitted from POS device 102 to AP server 106. In one embodiment, the user's financial instrument data is transmitted to AP server 106 along with an identification of the user that the financial instrument data is associated with.

At step 216, the user's financial instrument data is transmitted from AP server 106 to payment server 110. Payment server 110 then determines a financial institution associated with the financial instrument identified in the financial instrument data and prepares a query to determine if the financial instrument is valid.

At step 218, payment server 110 transmits a query to financial server 112 to determine if the financial instrument provided by the user is valid. In response to the query, payment server 110 receives a message from financial server 112 indicating whether or not the financial instrument provided by the user is valid.

At step 220, payment server 110 associates the user's financial instrument with the user in response to a message from financial server 112 indicating that the financial instrument is valid. Payment server 110 can then identify a particular financial instrument of a user based on an identity of a user provided by, for example, AP server 106.

At step 222, payment server 110 transmits user information and financial instrument information to AP server 106. AP server 106 and payment server 110 can then identify financial instruments associated with a particular user based on the user's identity determined from a fingerprint received by AP server 106 from POS device 102.

At step 224, an approval notice is transmitted from AP server 106 to POS device 102. The approval notice, in one embodiment, includes information indicating that the user personal information has been stored and that the user's financial instrument has been approved for use in making purchases.

At step 226, an approval notice is displayed to the user by POS device 102. A user can then make purchases using a biometric identifier at a POS, such as POS device 102.

In one embodiment, a user can provide more than one financial instrument as well as additional information, such as a user's personal information, information concerning a user's membership in a loyalty program, a user's preferences, etc. Information concerning additional financial instruments can be acquired as described above in connection with FIGS. 2A and 2B. In one embodiment, when more than one financial instrument is associated with a particular user, the user can select one of the financial instruments to be used as a default. Purchases by the user will then be processed using the default financial instrument. In one embodiment, while a user is making a purchase, the user is be prompted to select one of the financial instruments a user has entered into the system to complete a purchase. A user can also update their profile by changing information such as the user's personal information and financial instrument information.

With respect to loyalty programs, a user's purchases may be used to automatically inform a server associated with the loyalty program to be notified of the purchase so that the user's purchases can be tracked and rewarded as per loyalty program rules. For example, authentication and payment server 106 can communicate with a server associated with an entity responsible for the loyalty card and can transmit information concerning the loyalty cards.

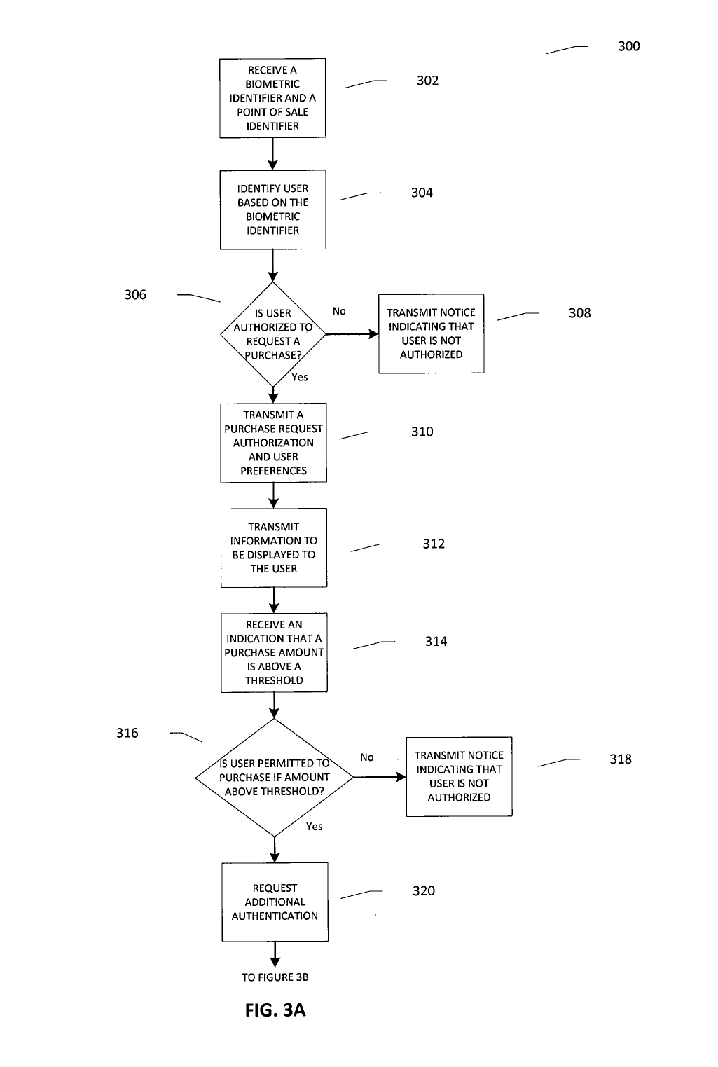

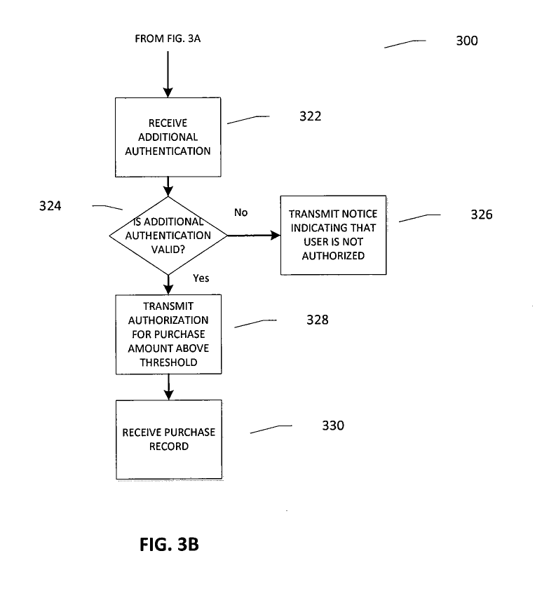

After a user has been enrolled with the system, the user can make purchases using a biometric identifier. FIGS. 3A and 3B depict a flow chart of a method 300 for making a purchase according to one embodiment.

At step 302, a biometric identifier and a point of sale identifier are received by AP server 106 from POS device 102 in response to a user presenting a biometric identifier at POS device 102. For example, a user operates a fingerprint scanner at POS device 102 and, in response, POS device 102 transmits a biometric identifier based on a scan of the user's fingerprint to AP server 106 along with a point of sale identifier. In one embodiment, a point of sale identifier is a unique identifier (e.g., a numeric or alphanumeric identifier) that can be used to identify a particular point of sale. In one embodiment, AP server 106 contains a point of sale table that can be used to identify a particular point of sale using a point of sale identifier. In one embodiment, the point of sale table also includes information about the point of sale such as location, products available, etc.

At step 304, AP server 106 identifies a user based on the biometric identifier. In one embodiment, AP server 106 compares the biometric identifier received from POS device 102 to a plurality of biometric identifiers stored in a table of AP server 106. Each of the plurality of biometric identifiers is associated with a particular user so that matching a biometric identifier received from POS device 102 with one of the plurality of biometric identifiers stored in AP server 106 results in an identification of a user associated with the one of the plurality of biometric identifiers. In another embodiment, the biometric identifier received from POS device 102 is transmitted to biometric server 108 for identification of a user associated with the biometric identifier. Biometric server 108, in one embodiment, stores a table in which each of a plurality of biometric identifiers is associated with a user. In one embodiment, biometric server 108 performs identification of a user based on a biometric identifier and transmits a user identification to AP server 106.

At step 306, AP server 106 determines whether the user is authorized to request a purchase. In one embodiment, this determination is based on identification of the user and identification of the point of sale and comparing these two identifications to a record associated with the identified user. The record associated with the user can contain restrictions pertaining to where and when the user can make purchases and what the user can purchase. In response to determining that the user is not authorized to request a purchase, the method proceeds to step 308 in which a notice is transmitted to POS device 102 indicating that the user is not authorized to make a purchase. In response to receiving the notice, POS device 102 displays an indication that the user is not authorized to make a purchase.

If the user is determined to be authorized to request a purchase, the method proceeds to step 310 in which AP server 106 transmits a purchase request authorization and user preferences to POS device 102. At step 312, AP server 106 transmits information to be displayed to the user. In one embodiment, receipt of the purchase request authorization triggers POS device 102 to display items that a user may purchase. In one embodiment, information pertaining to items a user may purchase is stored in POS device 102. In other embodiments, information about items a user may purchase is transmitted to POS device at step 312. Additional information, such as advertisements may also be transmitted from AP server 106 to POS device 102 for display to the user.

In one embodiment, a user completes a purchase by selecting an item available at POS device 102 and, in response, POS device 102 transmits a purchase record to AP server 106.

It should be noted that the accuracy of biometric identification can vary with the type of biometric identifier, the device used to acquire the biometric identifier, the method used to analyze the biometric identifier, and the method used to compare one biometric identifier to another. Since the accuracy of biometric identification can vary, in one embodiment, additional authentication may be required from a user for a purchase amount above a threshold. For example, any purchase under a specific dollar amount (e.g., $100) may be automatically authorized by POS device 102. For purchases above a threshold amount, in one embodiment, POS device 102 notifies AP server 106 of an attempted purchase above a threshold amount.

At step 314, POS device 102 transmits an indication that a purchase amount is above a threshold to AP server 102. In response, at step 316, AP server 106 determines if the user is permitted to make a purchase for an amount above the threshold by checking a user record of the user contained in a table stored in AP server 106. If the user is not permitted to make a purchase for an amount above the threshold, the method proceeds to step 318 in which AP server 106 transmits a notice to POS device 102 indicating that the user is not authorized to make a purchase for an amount over the threshold. POS device 102 then displays an indication that the user is not authorized to make the purchase for an amount over the threshold. If AP server 106 determines that the user is permitted to make purchases above a threshold, the method proceeds to step 320 in which AP server 106 transmits a request to POS device 102 to request additional authentication from the user.

At step 320, AP server 106 transmits a request for additional authentication to POS device 102. In response POS device 102 requests the user to enter additional authentication. Additional authentication can comprise one or more of a PIN, a biometric identifier different from the biometric identifier received in step 302, and/or authorization using a user device. In response to receipt of the additional authentication from the user, POS device 102 transmits the additional authentication to AP server 106. AP server 106 then compares the additional authentication to information stored in a record associated with the user in order to determine if the additional authentication is valid. In response to determining that the additional authentication is not valid, the method proceeds to step 326 in which a notice is transmitted from AP server 106 to POS device 102 indicating that the user is not authorized to make a purchase for an amount above the threshold. In response to AP server 106 determining that the additional authentication is valid, at step 328, AP server 106 transmits authorization to POS device 102 indicating that the user is authorized to make a purchase for an amount above the threshold. In response to this indication, POS device 102 completes the purchase attempted by the user and, in one embodiment, provides the user with the item purchased. POS device 102 then transmits a purchase record to AP server 106 indicating that the attempted purchase by the user has been completed. AP server 106, in one embodiment, then transmits information to payment server 110 which interacts with financial institution server 112 in order to record the transaction.

In the embodiment described above, a user enrolls via POS device 102 which has a biometric identifier input device (e.g., a fingerprint scanner) and a method for receiving payment (e.g., credit card scanner). Other devices may have additional devices and interfaces. For example, a particular POS device may have an input device, such as a keyboard and screen, or a touchscreen, for receiving a user's personal information, such as name, address, etc. In addition, multiple biometric identifiers may be acquired during enrollment. For example, a fingerprint may be acquired during enrollment for use as a primary identifier of a user. A retinal scan may also be acquired during enrollment and used later by system 100 to approve purchases for amounts above a threshold.

Although the methods described above are presented for use with a POS device, these methods may be used with other types of devices as well. For example, the methods described above may be used to restrict access to a locked cabinet, such as a jewelry cabinet in a retail store. The methods described above may also be used to prevent access to certain areas by unlocking doors to the areas only to authorized users. In such embodiments, a user can be required to provide a biometric identifier and/or additional authentication in order to access the contents of a locked cabinet or to access restricted areas located behind locked doors.

In one embodiment, transmissions between components may be encrypted or otherwise secured in order to prevent other parties from obtaining a user's information.

In one embodiment, multiple users may be associated with one or more financial instruments of a particular user. For example, a particular user's spouse and/or children may be associated with one or more financial instruments of the particular user. The particular user may place restrictions on purchases that can be made by the other users associated with the particular user's financial instruments. For example, if the particular user is the parent of another user, the particular user can restrict when and what purchases can be made by a child user associated with the particular user's financial instruments. Restriction information can be entered by the particular user via a POS device (such as POS device 102 of FIG. 1) or via communication with AP server 106 via a personal computer or device (not shown). Restriction information, in one embodiment, is stored in AP server 106 and is used to determine if purchase requests should be authorized for users associated with the particular user's financial instruments.

Multiple transactions can be performed in response to a user providing a biometric identifier. For example, a first transaction requires a user to provide their biometric identifier. After the first transaction is completed, the user can be asked if they want to perform an additional transaction. The user can then perform one or more transactions after having entered their biometric identifier for the first transaction. The opportunity to perform an additional transaction may be limited to a predetermined time period in order to prevent someone other than the user requesting an additional transaction if the user who provided the biometric identifier leaves the area of the device which received the biometric identifier (e.g. the point of sale device).

In one embodiment, system 100 of FIG. 1 supports micropayments. A micropayment is a financial transaction involving a small amount of money (e.g., a transaction for less than one dollar). In one embodiment, authentication and payment server 106 tracks micropayments made by a user and completes a transaction for multiple micropayments after a specific total of micropayment amounts have been made. For example, authentication and payment server 106 can track micropayments made by a user and complete a single transaction for the total amount of micropayments after the total amount is greater than a specific amount (e.g., five dollars). In one embodiment, each micropayment is processed in the same manner as non-micropayment transactions as previously described.

In one embodiment, a user may select multiple financial instruments for one transaction. For example, a user may want to pay for half of a transaction using one financial instrument, such as a credit card, and pay for the other half of the transaction using a different financial instrument, such as a debit card. In one embodiment, the user is presented with an option to select which financial instrument(s) should be used for the transaction. A user can select a first financial instrument and an amount of the transaction that the first financial instrument should be used for. The user can then select a second financial instrument and an amount of the transaction that the second financial instrument should be used for. In one embodiment, more than two financial instruments can be used for a transaction.

System 100 of FIG. 1 can also be used for authentication and/or providing information other than financial information to a third party. For example, a user's passwords, driver's license number, social security number, personal identification numbers, telephone numbers, work and/or home address, and any other information that is required to be communicated to a third party by a user can be stored and associated with one or more of a user's biometric identifiers. During enrollment, information that the user wants to provide to third parties is entered by the user and stored by system 100. In one embodiment, information that the user wants to provide to third parties is associated with the user and can be stored in one or more of authentication and payment server 106 and biometric server 108.

In one embodiment, users can be authenticated to third parties by the third party contacting authentication and payment server 106. For example, a third party who wants to authenticate a user requests the user to provide a biometric identifier. The third party transmits the biometric identifier to authentication and payment server 106 which identifies the user using the biometric identifier. Authentication and payment server 106 then transmits an identification of the user to the third party in response to the biometric identifier received from the third party. The third party can then determine if the user is who they claim to be. In one embodiment, the third party transmits a biometric identifier of a user and user identification, such as a user's name, to authentication and payment server 106. Authentication and payment server 106 can respond by confirming that the biometric identifier is associated with the user name provided by the third party. If the user name and biometric identifier do not correspond, authentication and payment server 106 transmits an indication to the third party that the biometric identifier does not correspond to the user name provided. Authentication can be used by third parties to allow users to access information, websites, containers, or physical locations based on whether the user is authenticated by system 100 of FIG. 1.

In one embodiment, third parties can be provided with a user's personal information using the user's biometric identifier. In response to a request for personal information, a user can provide a third party with their biometric identifier. The biometric identifier can then be transmitted by a device associated with the third party to authentication and payment server 106 with a request for user information. Authentication and payment server 106 can retrieve user information and transmit the information to the third party. By providing user information from authentication and payment server 106, a user does not have to enter any of their personal information when requested by the third party. Since the user does not have to enter the information in response to the third party request, the information will not be stored in a cache locally by the third party and the information cannot be captured by, for example, a keystroke logger. In one embodiment, a request from a third party for a user's information can include one or more of a user's biometric identifier, an additional user identifier (e.g., the user's name), an identification of the third party, and a list of personal information the third party is requesting from the authentication and payment server 106. In response to a valid request, authentication and payment server 106 transmits the requested personal information to the third party. In one embodiment, the request and personal information transmitted can be encrypted and/or sent using tunneling techniques to prevent other parties from obtaining the user's information.

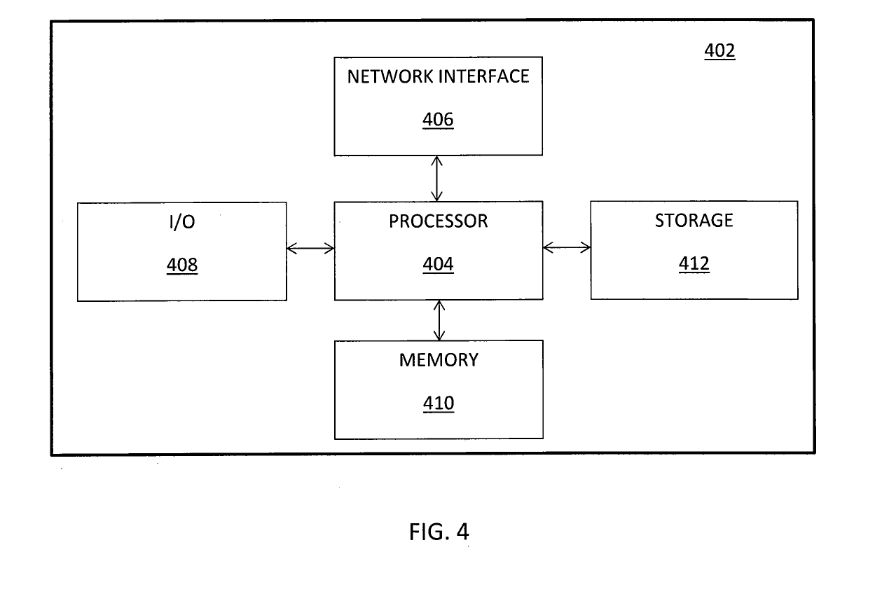

POS device 102, AP server 106, biometric server 108, payment server 110, and financial institution server 112 can each be implementing on a computer. A high-level block diagram of such a computer is illustrated in FIG. 4. Computer 402 contains a processor 404 which controls the overall operation of the computer 402 by executing computer program instructions which define such operation. The computer program instructions may be stored in a storage device 412, or other computer readable medium (e.g., magnetic disk, CD ROM, etc.), and loaded into memory 410 when execution of the computer program instructions is desired. Thus, the method steps of FIGS. 2A, 2B, 3A, and 3B can be defined by the computer program instructions stored in the memory 410 and/or storage 412 and controlled by the processor 404 executing the computer program instructions. For example, the computer program instructions can be implemented as computer executable code programmed by one skilled in the art to perform an algorithm defined by the method steps of FIGS. 2A, 2B, 3A, and 3B. Accordingly, by executing the computer program instructions, the processor 404 executes an algorithm defined by the method steps of FIGS. 2A, 2B, 3A, and 3B. The computer 402 also includes one or more network interfaces 406 for communicating with other devices via a network. The computer 402 also includes input/output devices 1008 that enable user interaction with the computer 402 (e.g., display, keyboard, mouse, speakers, buttons, etc.) One skilled in the art will recognize that an implementation of an actual computer could contain other components as well, and that FIG. 4 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method comprising:
receiving, at an authentication and payment server, a biometric identifier and a point of sale identifier;
identifying, by the authentication and payment server, a user based on the biometric identifier;
determining, by the authentication and payment server, whether the user is authorized to request a purchase at a point of sale device identified by the point of sale identifier;
transmitting, by the authentication and payment server, a purchase request authorization and user preferences of the user to the point of sale device in response to determining that the user is authorized to request a purchase at the point of sale device.

2. The method of claim 1, wherein the user preferences are based on prior purchases made by the user and the user preferences reflect one of parental restrictions and legal restrictions.

3. The method of claim 2, further comprising:
transmitting information to be displayed to the user, the information to be displayed based on the user preferences.

4. The method of claim 1, further comprising:
receiving an indication that a purchase amount is above a threshold;
transmitting a request for additional authentication;
receiving the additional authentication;
determining if the additional authentication is valid; and
transmitting authorization for the purchase amount above the threshold in response to determining that the additional authentication is valid.

5. The method of claim 1, further comprising:
receiving an enrollment request;
enrolling the user associated with the enrollment request by associating the user with the biometric identifier of the user and a financial instrument provided by the user.

6. The method of claim 1, further comprising:
receiving a purchase record.

7. The method of claim 2, wherein the user preferences are further based on information previously provided by the user.

8. An apparatus comprising:
a processor; and
a memory to store computer program instructions, the computer program instructions when executed on the processor cause the processor to perform operations comprising:
receiving a biometric identifier and a point of sale identifier;
identifying a user based on the biometric identifier;
determining whether the user is authorized to request a purchase at a point of sale device identified by the point of sale identifier; and
transmitting a purchase request authorization and user preferences of the user to the point of sale device in response to determining that the user is authorized to request a purchase at the point of sale device.

9. The apparatus of claim 8, wherein the user preferences are based on prior purchases made by the user and the user preferences reflect one of parental restrictions and legal restrictions.

10. The apparatus of claim 9, the operations further comprising:
transmitting information to be displayed to the user, the information to be displayed based on the user preferences.

11. The apparatus of claim 8, the operations further comprising:
receiving an indication that a purchase amount is above a threshold;
transmitting a request for additional authentication;
receiving the additional authentication;
determining if the additional authentication is valid;
transmitting authorization for the purchase amount above the threshold in response to determining that the additional authentication is valid.

12. The apparatus of claim 8, the operations further comprising:
receiving an enrollment request;
enrolling the user associated with the enrollment request by associating the user with the biometric identifier of the user and a financial instrument provided by the user.

13. The apparatus of claim 8, the operations further comprising:
receiving a purchase record.

14. The apparatus of claim 9, wherein the user preferences are further based on information previously provided by the user.

15. A computer readable medium storing computer program instruction, which, when executed on a processor, cause the processor to perform operations comprising:
receiving, at an authentication and payment server, a biometric identifier and a point of sale identifier;
identifying, by the authentication and payment server, a user based on the biometric identifier;
determining, by the authentication and payment server, whether the user is authorized to request a purchase at a point of sale device identified by the point of sale identifier; and
transmitting, by the authentication and payment server, a purchase request authorization and user preferences of the user to the point of sale in response to determining that the user is authorized to request a purchase at the point of sale.

16. The computer readable medium of claim 15, wherein the user preferences are based on prior purchases made by the user and the user preferences reflect one of parental restrictions and legal restrictions.

17. The computer readable medium of claim 16, the operations further comprising:
transmitting information to be displayed to the user, the information to be displayed based on the user preferences.

18. The computer readable medium of claim 15, the operations further comprising:
receiving an indication that a purchase amount is above a threshold;
transmitting a request for additional authentication;
receiving the additional authentication;
determining if the additional authentication is valid;
transmitting authorization for the purchase amount above the threshold in response to determining that the additional authentication is valid.

19. The computer readable medium of claim 15, the operations further comprising:
receiving an enrollment request;
enrolling the user associated with the enrollment request by associating the user with the biometric identifier of the user and a financial instrument provided by the user.

20. The computer readable medium of claim 15, the operations further comprising:
receiving a purchase record.
